(19) United States
(12) Patent Application Publication
(10) Pub. No.: US 2009/0065422 A1
(43) Pub. Date: Mar. 12, 2009

(54) Cock for water purifier

(76) Inventor: Yen-Tsun Lai, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/898,383

(22) Filed: Sep. 12, 2007

(51) Int. Cl. C02F 1/00

(52) U.S. Cl. 210/257.1

(57) ABSTRACT

This invention relates to a cock for water purifier which has a cock body formed with two compartments partitioned with each other. One of the two compartment is provided with a tap-water passage, and then a water input passage connecting with the water inlet of the water purifier is provided adjacent to the tap-water passage, and a conversion switch for opening and closing the water input and the water output is also disposed in the same compartment. Then, a water output passage connecting with the water outlet of the water purifier is provided in the other compartment of the cock body. In this way, the cock is activated to switch between opening state and closing state of the piping associated with the flow-in of the tap water to the water purifier or the flow-out of the cleaned water from the water purifier. Therefore, such damages as rupture or water leakage of the water purifier caused by the continuous rendering of impact came from the water-hammer action formed by the sustaining applied pressure of the tap-water to the water purifier during cease of the drinking of cleaned water can be avoided.

### BACKGROUND OF THE INVENTION

1. Field of the Invention

The present invention relates to a cock for water purifier, particularly to a cock for water purifier capable of switching between opening state and closing state of the piping associated with the flow-in of the tap water to the water purifier or the flow-out of the cleaned water from the water purifier such that the water hammer action caused by the continuous application of water pressure from tap-water onto the water purifier during the cease of drinking cleaned water can be avoided so as to prevent the water purifier from cracking and leaking.

2. Brief Description of the Prior Art

Nowadays, environmentally contaminants is overwhelming allover the places accompanying with the development of industries, such as the arbitrary dumping of rubbish and unpermitted discharge of industrial wastewater, especially dropping of acid rain caused by the discharge of untreated waste gases into the atmosphere haphazardly. Thus, the water sources such as river or lake are seriously polluted such that people are always doubt about the cleanness of living water and dare not try to drink it.

In order to pursue the cleanness of living water at the terminal, some filtering processes such as reverse osmosis (RO), water electrolysis, distilling or active carbon filtering are generally utilized to enhance the cleaning action of the tap-water supplied from the waterworks or water sources so as to prevent the water from contamination by impurities, bacteria, chemically harmful or toxic substances. In this manner, the water purification can be ensured and thus the inadaptability of human body or disease caused by uncleaned water can be avoided.

The piping design of existing ordinary water purifier, for example a RO water purifier, is mainly a tap-water piping communicating with the tap-water supply source, and the tap-water piping is connected to a RO water purifier. Then, a water-storing piping is connected from the RO water purifier to a water tank, and a water discharge piping is connected from the RO water purifier to a cock.

According to this configuration, the tap-water is inputted from the tap-water piping and passes through the RO membrane of the RO water purifier by the applied pressure thereof to form the cleaned RO water. Then, the cleaned RO water is divided into two streams, one is stored in the water tank after flowing through the water-storing piping into it, and the other one is connected to the cock through the water discharge piping. People can drink the cleaned RO water by just opening the cock.

From the above configuration, the normally-existing tap-water uninterruptedly flows into the RO water purifier through the tap-water piping, and moves towards the RO membrane within the RO water purifier by the impact came from the water-hammer action formed by the applied pressure of the tap-water, and is pushed through the RO membrane to form cleaned RO water. The cleaned RO water flowing out continuously moves into the water tank uninterruptedly for storing until the water pressure within the water tank in full state is in equilibrium with the tap-water pressure. Then, the filtering and storing processes is temporarily stopped. Once the water pressure in both sides is in unbalanced condition, then the filtering and storing processed is restarted.

Because the RO membrane, the piping and the filter case bodies of the RO water purifier suffer long time impact came from the water-hammer action formed by the applied pressure from the tap-water, some defects such as water leakage at pipe joints, water leakage at the crack produced on the filter case bodies or the engagement portions caused by aging are prone to happen. In other words, the RO water purifier is easily deteriorated and the service lifetime is thus shortened.

In addition, the cleaned RO water in the water tank is always kept at full state so that the water pressure in the water tank is in relatively high pressure state all the time. Once the water tank is corroded or there is any connection failure in the structure, water leakage is easily happened. The leakage of cleaned water not only dampens the environment but also damages the furniture nearby, further causes the danger of electrical fire if water leakage is in proximity to electrical appliance.

In view of the above fact, the inventor of the present invention develops a cock for water purifier after endless devotion to the research and development aiming at improving and removing the defects on the structural design of water input and water output piping in the conventional water purifier, based on the abundant professional knowledge accumulated and practical manufacturing experience in the relevant field, so that a solution for the above problem can be highly expected.

### SUMMARY OF THE INVENTION

The object of this invention is to provide a cock for water purifier which can prevent the RO membrane and the water purifying circuit such as the piping and the filter case bodies of the RO water purifier from damaging during the cease of drinking the cleaned RO water.

The cock for water purifier of the present invention has a cock body which is formed with two compartments partitioned with each other. One of the two compartment is provided with a tap-water passage, and then a water input passage connecting with the water inlet of the water purifier is provided adjacent to the tap-water passage, and a conversion switch for opening and closing the water input and the water output is also disposed in the same compartment. Then, a water output passage connecting with the water outlet of the water purifier is provided in the other compartment of the cock body. In this way, the cock is activated to switch between opening state and closing state of the piping associated with the flow-in of the tap water to the water purifier or the flow-out of the cleaned water from the water purifier such that the RO membrane of the RO water purifier is prevented from damaging by the sustained applied pressure from the tap-water during the cease of drinking the cleaned RO water. In addition, since the cock is activated to switch between an opening state, in which the tap water flows into the water purifier, and a closing state, in which the cleaned water flows out from the water purifier, the supply of tap-water to the RO water purifier is conducted only when the drinking of the cleaned RO water is needed. Thus, there is no need to provide a water tank for storing cleaned water, such defects as the dampening of environment by the leakage of cleaned water from the cracked water tank, damaging of furniture, or electrical fire of electrical appliance can be eliminated.

### BRIEF DESCRIPTION OF THE DRAWINGS

The present invention will be better understood by the detailed description of a preferred embodiment with reference to the accompanying drawings, in which:

FIG. 1 is a perspective exploded view showing the cock for water purifier of the present invention.

FIG. 2 is a perspective sectional view (1) showing the cock for water purifier of the present invention.

FIG. 3 is a perspective sectional view (2) showing the cock for water purifier of the present invention.

FIG. 4 is a sectional plan view showing the cock for water purifier of the present invention.

FIG. 5 is a view showing the using state (1) of the cock for water purifier of the present invention.

FIG. 6 is a view showing the using state (2) of the cock for water purifier of the present invention.

FIG. 7 is a view showing the using state (3) of the cock for water purifier of the present invention.

FIG. 8 is a view showing the using state (4) of the cock for water purifier of the present invention.

### DETAILED DESCRIPTION OF THE PREFERRED EMBODIMENTS

The technical contents of the present invention will become more apparent from the detailed description of the preferred embodiments in conjunction with the accompanying drawings.

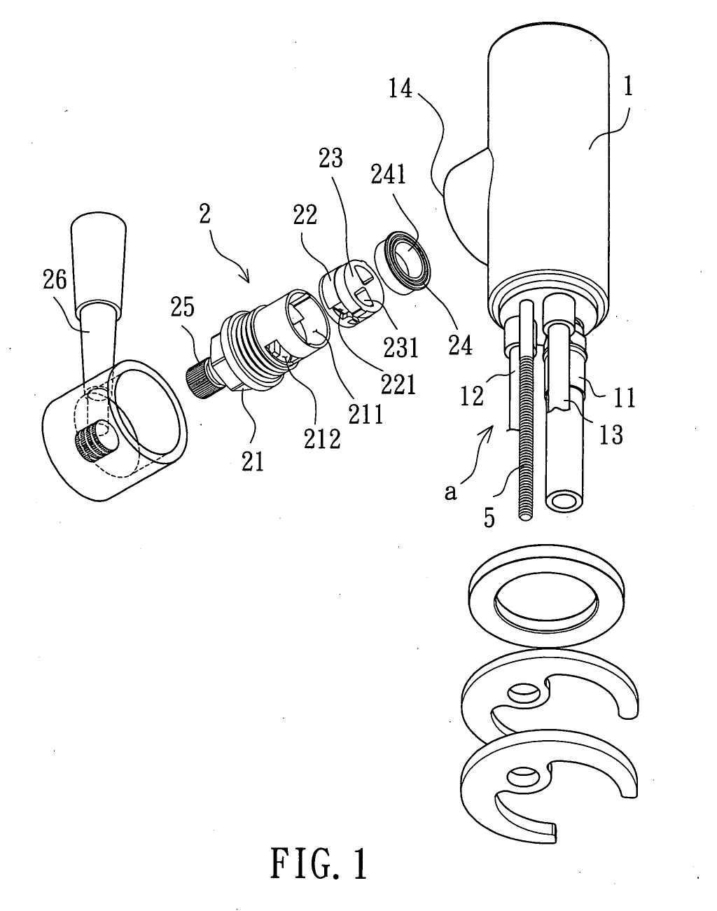

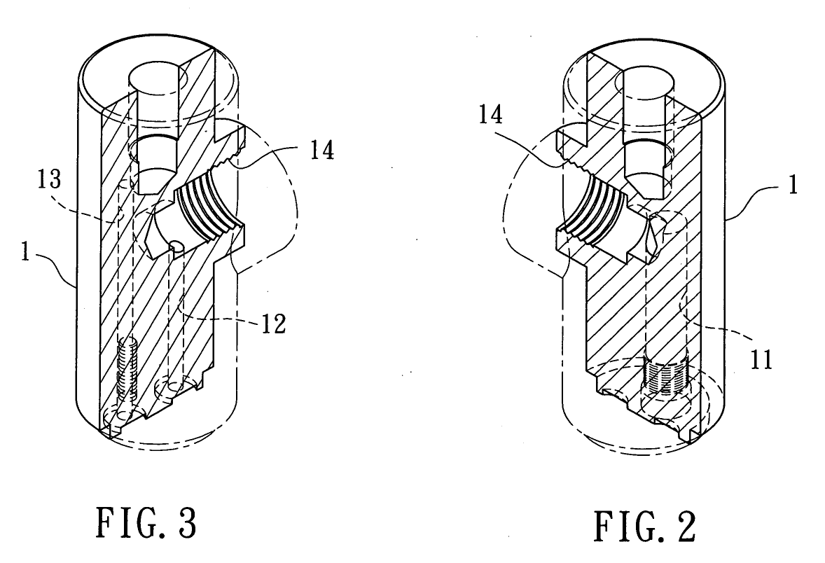

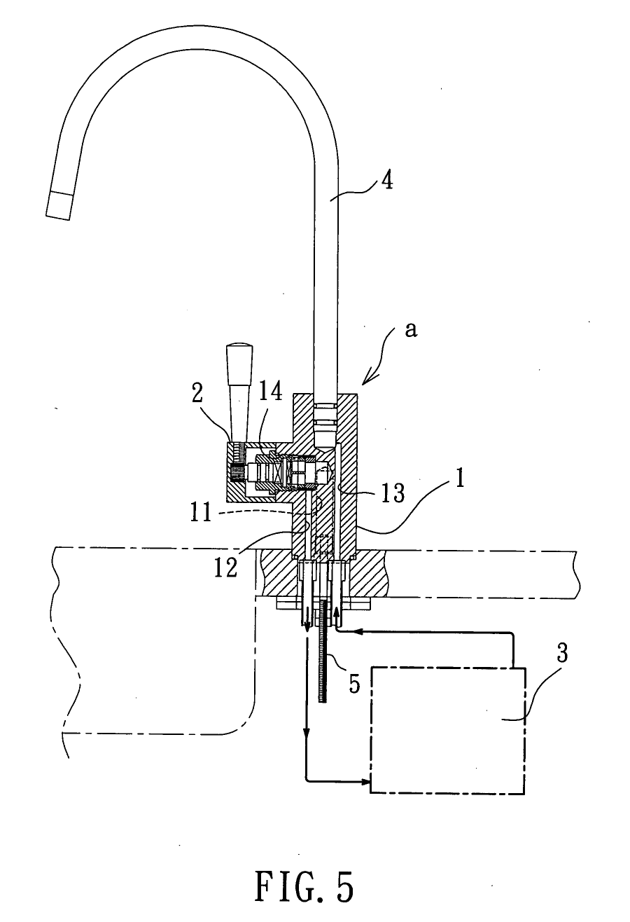

Firstly referring to FIG. 1, the cock (a) for water purifier of the present invention is mainly formed by a cock body (1) combined with a tap-water passage (11), water input and out passages (12), (13), and a conversion switch (2) for water-in and water-out switching. The cock body (1), as shown in FIGS. 2 and 3, is formed with two compartments partitioned with each other. One of the two compartment is provided with : a tap-water passage (11) connecting with tap-water source by a high-pressure hose ; a water input passage (12) connecting with the water inlet of the water purifier (3) and provided adjacent to the tap-water passage (11) as shown in FIG. 5 ; and a socket (14) in which a conversion switch (2) is mounted therein.

Then, a water output passage (13) connecting with the water outlet of the water purifier (3) is provided in the other compartment of the cock body (1). The water output passage (13) is connected with a cleaned water output pipe (4), as shown in FIG. 5.

Furthermore, a screw rod (5) is fixed on the cock body (1) for the fastening of the cock body (1) on the kitchen table.

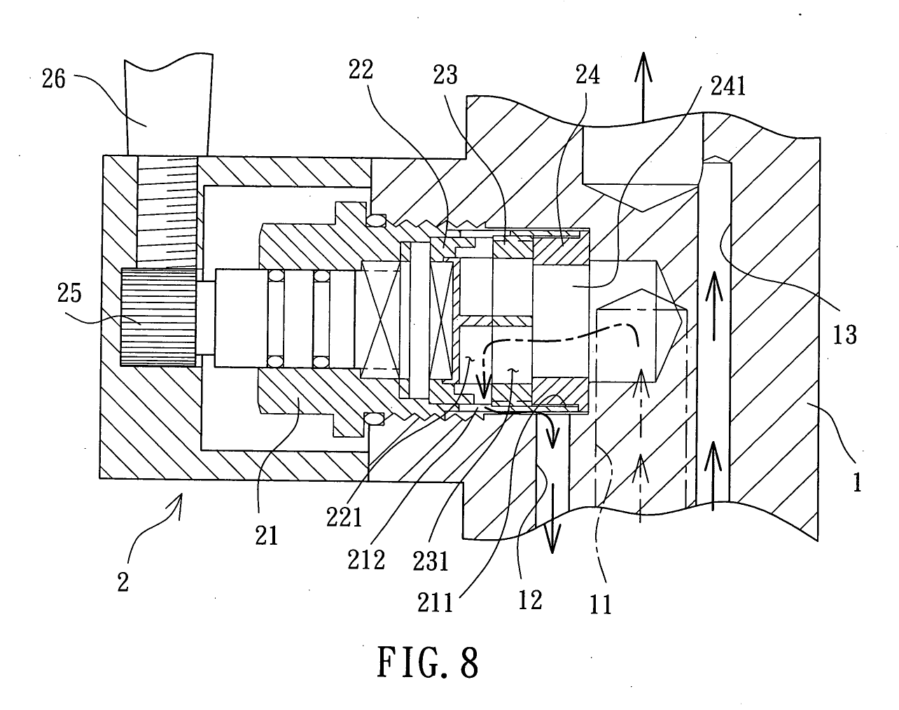

As shown in FIG. 1, the conversion switch (2) is disposed within the socket (14) of the cock body (1), which has a conversion switch body (21). The conversion switch body (21) has a through hole (211) with a rotation plug (22), a flow guide block (23) and a gasket (24) mounted therein in this order. The through hole (211) is associated with the tap-water passage (11) of the cock body (1), as shown in FIG. 8.

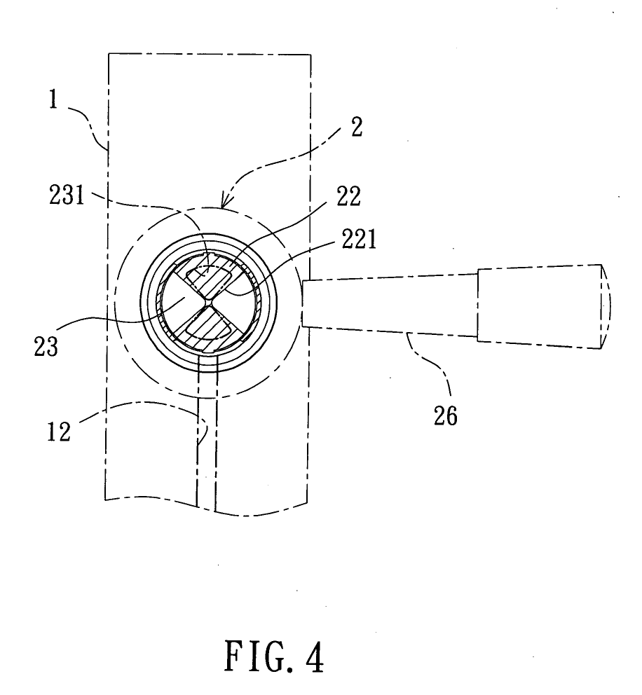

The rotation plug (22) has a notch portion (221). As shown in FIG. 4, the flow guide block (23) has a penetration hole (231) corresponding to the notch (221) of the rotation plug (22). An opening (212) is provided at the side of the conversion switch body (21) corresponding to the notch (221) of the rotation plug (22). The penetration hole (231) of the flow guide block (23) is made to be at the same side with the opening (212) of the conversion switch body (21). The opening (212) of the conversion switch body (21) is associated with the water input passage (12) of the cock body (1), as shown in FIG. 8.

A rotation rod (25) is rotably provided in the conversion switch body (21), which is connected with the rotation plug (22). A lever (26) is fixed on the rotation rod (25).

According to this configuration as shown in FIG. 5, in the installation of the cock for water purifier, the cock (a) for water purifier of the present invention is fixed on the kitchen table by the screw rod (5) provided of the cock body (1). Then, the tap-water passage (11) is connected with the tap-water source, and the water input passage (12) and the water output passage (13) are respectively connected with the water inlet and water outlet of the water purifier (3).

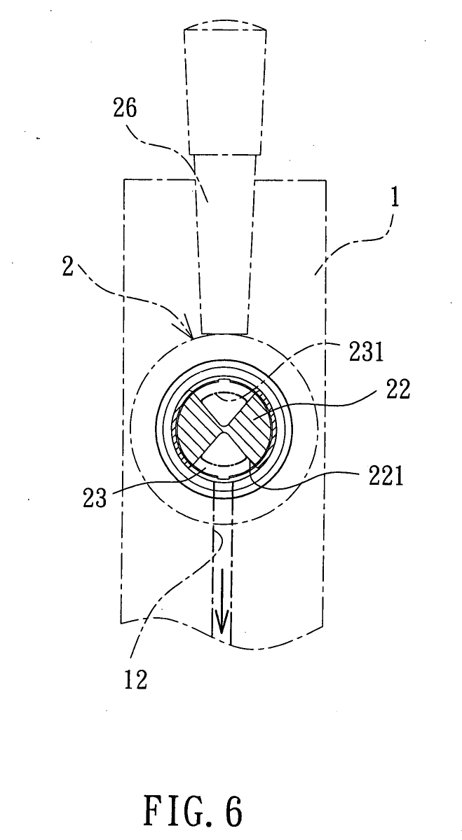

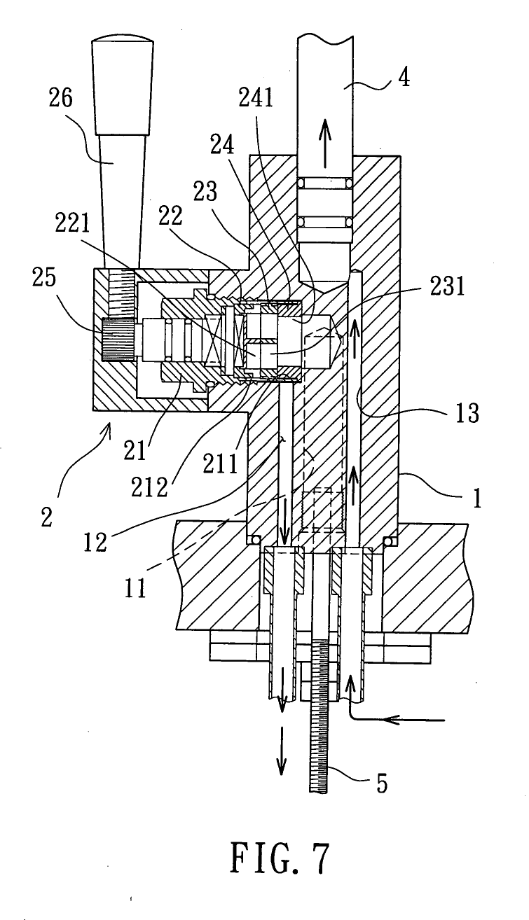

When there is a demand to drink the cleaned RO water, as shown in FIGS. 6 and 7, the lever (26) of the conversion switch (2) is rotated in such manner that the notch (221) on the rotation plug (22) is aligned with the penetration hole (231) of the flow guide block (23). Thus, the communication between the tap-water passage (11) and the water input passage (12) is established.

In FIGS. 7 and 8, after getting across the through hole (211) provided on the conversion switch body (21) from the tap-water passage (11) of the cock body (1), the tap-water moves through a circular hole (241) formed along the gasket (24) and the penetration hole (231) provided on the flow guide block (23) and the notch (221) provided on the rotation plug (22), and flows out through the opening (212) provided on the side of the conversion switch body (21).

Referring again to FIG. 5, the tap-water flowing through the water input passage (12) enters into the water purifier (3) from its water let. The tap-water is pushed through the filtering membrane of the water purifier (3) by the action of water hammer formed by the applied water pressure of the tap-water, and the cleaned RO water is thus formed after passing through the membrane. Then the cleaned RO water moves out from the water outlet of the water purifier (3) and flows to the water output passage (13) communicated with the water outlet of the water purifier (3), finally flows out of the cleaned water output pipe (4) communicated with the water output passage (13) to provide cleaned water for end user.

When user needs not to drink cleaned water, referring to FIGS. 5 and 8, the lever (26) of the conversion switch (2) is rotated back to its original position. At this moment, the notch (221) on the rotation plug (22) of the conversion switch (2) is rotated to move away from the position aligned with the penetration hole (231) of the flow guide block (23) so that the penetration hole (231) of the flow guide block (23) is blocked. This will interrupt the communication between the tap-water passage (11) of the cock body (1) and the water input passage (12) so that the tap-water no more enters into the water purifier (3). In this manner, the defect of the possible early damage of the RO membrane, the filtering route and the whole water purifying piping by the sustained applied pressure from tap-water during the cease of drinking cleaned RO water to cause shortened service lifetime of the RO water purifier (3) can be avoided. With installation of the high-pressure hose between the tap-water passage and tap-water source, the leakage of water between the tap-water passage and tap-water source can be further avoided and no water hammering action from water pressure will be incurred.

Additionally, the supply of tap-water to the RO water purifier (3) is conducted only when the drinking of RO water is needed. Thus, there is no need to provide a water tank for storing cleaned water, such defects as the dampening of environment by the leakage of cleaned water from the cracked water tank, damaging of furniture, or electrical fire of electrical appliance can be eliminated.

Based on the foregoing, the present invention has a number of merits as follow when comparing with the prior art

1. The cock for water purifier of the present invention is activated to switch between opening state and closing state of the piping associated with the flow-in of the tap water to the water purifier or the flow-out of the cleaned water from the water purifier such that the piping for the supply of the tap-water to the water purifier can be closed during the cease of drinking the cleaned RO water so as to avoid the continuous rendering of impact came from the water-hammer action formed by the sustaining applied pressure of the tap-water to the filtering circuit. Therefore, such defects as easy deterioration or thus the shortening of service lifetime of the water purifier caused by the water leakage at pipe joints, the water leakage at the crack produced on the filter case bodies or the engagement portions by aging effect can be avoided.

2. Inasmuch as the cock for water purifier of the present invention is activated to switch between opening state and closing state of the piping associated with the flow-in of the tap water to the water purifier or the flow-out of the cleaned water from the water purifier, there is no need to provide a water tank for storing cleaned water, such defects as the dampening of environment by the leakage of cleaned water from the cracked water tank, damaging of furniture, or electrical fire of electrical appliance can be eliminated.

3. the cock for water purifier of the present invention is particularly provided with a high-pressure hose on the joint of the tap-water passage and tap-water source, and with such best installation, the leakage of water between the tap-water passage and tap-water source can be further avoided and no water hammering action from water pressure will be incurred for breaking of the hose.

Summing up above, the embodiment of the cock for water purifier of this invention can reach expected effectiveness, and the specific configurations disclosed herein have yet not seen in the prior art of the same category of product, even has not been opened to the public before application.

While the present invention has been described with preferred embodiments in conjunction with the accompanying drawings, the preferred embodiments and the drawings are purely for the convenience of description only, and are not intended to be restrictive of the scope of the present invention. It is noted that various modifications and variations made without departing from the spirit of the present invention is considered to be still within the scope of the present invention.

What is claimed is:

1. A cock (a) for water purifier, wherein said cock (a) has a cock body (1) which is formed with two compartments partitioned with each other, one of the two compartment has a tap-water passage (11), a water input passage (12) provided adjacent to the tap-water passage (11), which is connected with the water inlet of the water purifier (3) and a socket (14) in which a conversion switch (2) is mounted;
a water output passage (13) connecting with the water outlet of the water purifier (3) is provided in the other compartment of the cock body (1).

2. A cock (a) for water purifier as claimed in claim 1, wherein said conversion switch (2) includes a conversion switch body (21) which has a through hole (211) with a rotation plug (22), a flow guide block (23) and a gasket (24) mounted therein in this order, and the through hole (211) is associated with the tap-water passage (11) of the cock body (1),
said rotation plug (22) is closely adjacent to said flow guide block (23) and having a notch portion (221),
said flow guide block (23) has a penetration hole (231) corresponding to the notch (221) of said rotation plug (22),
an opening (212) is provided at the side of the conversion switch body (21) corresponding to the notch (221) of the rotation plug (22), the penetration hole (231) of the flow guide block (23) is made to be at the same side with the opening (212) of the conversion switch body (21), the opening (212) of the conversion switch body (21) is associated with the water input passage (12) of the cock body (1).

3. A cock (a) for water purifier as claimed in claim 2, wherein a rotation rod (25) is rotably provided in the conversion switch body (21), which is connected with the rotation plug (22).

4. A cock (a) for water purifier as claimed in claim 3, wherein said rotation rod (25) is combined with a lever (26) fixed on it.

5. A cock (a) for water purifier as claimed in claim 1, wherein said water output passage (13) is further communicated with a cleaned water output pipe (4).

6. A cock (a) for water purifier as claimed in claim 1, wherein a screw rod (5) is provided on the cock body (21) for the fixation on the kitchen table.

7. A cock (a) for water purifier as claimed in claim 1, wherein the cock body is further provided with a high-pressure hose being jointed between the tap-water passage (11) and a tap-water source.
